(19) United States
(12) Patent Application Publication
(10) Pub. No.: US 2009/0187877 A1
(43) Pub. Date: Jul. 23, 2009

(54) MULTI-PASS, CONSTRAINED PHASE ASSIGNMENT FOR ALTERNATING PHASE-SHIFT LITHOGRAPHY

(76) Inventor: Carl A. Vickery, III, Garland, TX (US)

Correspondence Address: TEXAS INSTRUMENTS INCORPORATED, P O BOX 655474, M/S 3999, DALLAS, TX, 75265, US

(21) Appl. No.: 12/017,699

(22) Filed: Jan. 22, 2008

(51) Int. Cl. G06F 17/50

(52) U.S. Cl. 716/19

(57) ABSTRACT

Generating two-tone phase shift photomasks that satisfy lithography and photomask constraints is accomplished using an iterative algorithm which successively identifies violations of the constraints, relaxes or removes constraints, and alters layout polygons associated with the violations, to produce a phase assignment configuration which meets the lithography and photomask constraints or identifies a subset of the layout polygons for which no viable solution can be found.

### FIELD OF THE INVENTION

This invention relates generally to the field of integrated circuits and more specifically to a method and system for photomask pattern correction.

### BACKGROUND OF THE INVENTION

Conventional optical projection lithography has been the standard silicon patterning technology for the past 20 years. It is an economical process due to its inherently high throughput, thereby providing a desirable low cost per part or die produced. A considerable infrastructure (including steppers, photomasks, resists, metrology, etc) has been built up around this technology.

In this process, a photomask, or “reticle”, includes a semiconductor circuit layout pattern consisting of a multitude of polygons, typically formed of a layer of an opaque or partially opaque material, on a transparent glass (typically SiO₂) substrate. As used herein, the term “polygon” refers to various geometric shapes that can be used to form a feature on a substrate. A stepper includes a light source and optics/lenses that project light coming through the reticle and images the semiconductor circuit layout pattern, typically with a 4× to 5× reduction factor, on a photo-resist film formed on a silicon substrate. Lateral dimensions of a pattern of the semiconductor circuit layout pattern formed in the photo-resist film are limited by the wavelength of the light source and the quality of the optics/lenses in the stepper, as well as the photolithographic process used to form the image.

As the semiconductor industry continues to evolve, feature sizes of the pattern are driven to smaller dimensions and higher spatial resolution. To meet this demand, Resolution-Enhanced optical lithography Technologies (“RET”) have become popular as techniques for providing patterns with sub-wavelength resolution. These methods include off-axis illumination (“OAI”), optical proximity correction (“OPC”), and phase-shift photomasks (“PSMs”). Such resolution-enhanced optical lithography methods are especially useful for generating physical devices on a substrate that require small size and tight design tolerance. Examples of such physical devices are a gate of an MOS transistor or contact holes formed in inter-layer dielectrics.

One of the most common commercial implementations of phase-shift photomask technology is the double exposure method. In this method, the critical features are imaged using a phase-shift photomask (“phase photomask”) and the non-critical and trim features are imaged in a second exposure using a conventional chrome-on-glass photomask, such as a trim photomask.

An example of a double exposure phase-shift method is illustrated in FIG. 1A through FIG. 1C. FIG. 1A depicts a pattern (100) to be formed on a substrate (102), including large elements (104) and minimum geometry elements (106) which have linewidths below the wavelength of the light source in the stepper. In this method, the minimum geometry elements (106) are imaged on the substrate (102), in the first exposure, using a phase-shift photomask (108), shown in FIG. 1B. The phase-shift photomask (108) includes phase-shift polygons (110) which transmit light while applying a phase-shift to the transmitted light. Typically, phase-shift polygons (110) include zero shift polygons (112) which transmit light without a phase-shift, and π shift polygons (114), which shift the phase of the transmitted light by π (3.14159 . . . ) radians, that is, 180 degrees. Adjacent phase-shift polygons of opposite phase, as depicted in FIG. 1B, form a narrow image in the photo-resist on the substrate, as desired. Regions (116) on the phase-shift photomask (108) outside the phase-shift polygons (110) are commonly covered with an opaque material, typically chromium metal, to block light from the stepper light source from exposing photo-resist on the substrate. Definition of large features (104) and trimming of undesired phase edges are performed in a second exposure using a trim photomask (118) shown in FIG. 1C. The trim photomask (118) includes a glass substrate (120), on which are formed opaque or partially opaque polygons to form the desired pattern in the photoresist. Large element polygons (122) have substantially the same dimensions as the large element (104), enlarged to account for any lens reduction factor (commonly 4× or 5×, as discussed above), and biased for any process dimensional shift, commonly less than 100 nanometers. The trim photomask (118) also includes protection polygons (124) for blocking light from minimum geometry elements (106) printed with the phase shift photomask, in which lateral dimensions of the protection polygons (124) are significantly larger than the desired feature dimension of the minimum geometry elements (106). The desired feature dimension of the minimum geometry elements (106) is produced by exposure using the phase-shift photomask (108) in combination with exposure using the trim photomask (118).

For a phase-shift photomask with two or more tones or phases, it is often difficult to assign a phase to each polygon in such a way that lithography and photomask constraints are met. Typical lithography and photomask constraints include a requirement that adjacent polygons that define a narrow feature on the substrate must have different phases, and adjacent polygons which do not define a feature on the substrate must be separated by a minimum lateral distance) while a larger lateral distance is preferred to provide photomask manufacturing and photolithography process margin. Some conventional methods of assigning phases to polygons have attempted to perform phase assignment or coloring without a priori knowledge of where lithography constraints and/or photomask constraints might occur. Other methods attempt to perform phase assignment in a single pass over a graph. Still other methods do not iteratively modify the phase assignments while attempting to find a phase assignment configurations for the entire phase-shift photomask that meets all lithography and photomask constraints.

Accordingly, the present invention solves these and other problems of the prior art using a method that converges quickly on an optimal phase assignment that meets the lithography and photomask constraints.

### SUMMARY OF THE INVENTION

In accordance with this invention, there is a method of configuring polygons and phase assignments for the polygons on an alternating phase-shift photomask, the method comprising the following steps:

identifying polygons in the phase-shift photomask layout which are likely to violate lithography and/or photomask constraints, and assigning these polygons to a first set;

assigning zero and at phases to as many polygons in the photomask layout as possible while satisfying the lithography and photomask constraints, using the first set of polygons to constrain and steer phase assignment;

storing phase assignment information on those polygons which meet lithography and photomask constraints, and assigning these polygons to a second set;

relaxing one or more of the lithography and/or photomask constraints;

repeating the above steps until either all polygons in the photomask layout have been assigned a phase which meets lithography and photomask constraints or a third set of polygons in the photomask layout is identified which cannot be assigned phases which meet lithography and photomask constraints.

In accordance with another embodiment of the invention there is a computer readable medium containing program code that configures a processor to perform a method of configuring polygons and phase assignments for the polygons an alternating phase-shift photomask. The computer readable medium can comprise program code for identifying polygons in the phase-shift photomask layout which are likely to violate lithography and/or photomask constraints, and assigning these polygons to a first set; program code for assigning zero and π phases to as many polygons in the photomask layout as possible while satisfying the lithography and photomask constraints, using the first set of polygons to constrain and steer phase assignment; program code for storing phase assignment information on those polygons which meet lithography and photomask constraints, and assigning these polygons to a second set; program code for relaxing one or more of the lithography and photomask constraints; and program code for repeating the above steps until either all polygons in the photomask layout have been assigned a phase which meets lithography and photomask constraints or a third set of polygons in the photomask layout is identified which cannot be assigned phases which meet lithography and photomask constraints.

In accordance with another embodiment of the invention there is a method of configuring polygons and phase assignments for the polygons on an alternating phase-shift photomask. The method can comprise the steps of (a) determining locations on the photomask layout where lithography and photomask constraints may be violated, wherein at each location, a polygon will be formed to eliminate the violation, if possible, (b) assigning zero and π phases to as many polygons in the layout, as modified by step a, as possible, while satisfying the lithography and photomask constraints, and (c) relaxing one or more of the lithography and photomask constraints and assigning zero and π phases to polygons which were not assigned phases in step b.

Additional advantages of the embodiments will be set forth in part in the description which follows, and in part will be obvious from the description, or may be learned by practice of the invention. The advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1A is a diagram illustrating a substrate formed using a conventional double exposure method;

FIG. 1B. is a diagram illustrating a phase-shift photomask in a conventional double exposure method;

FIG. 1C is a diagram illustrating a trim photomask in a conventional double exposure method;

FIG. 2 illustrates a system for designing and correcting a photomask according to the present teachings.

FIG. 3 is a flowchart illustrating one embodiment of a method embodying the instant invention.

FIG. 4A through 4C depict a photoresist pattern and a two-tone phase-shift photomask and a trim photomask to illustrate a method of assigning phases.

FIG. 5A is a diagram illustrating a photoresist pattern that includes multiple polygons with narrow linewidth features.

FIG. 5B is a diagram illustrating an initial layout for a two-one phase-shift photomask for the photoresist pattern depicted in FIG. 5A.

FIG. 5C is a diagram illustrating an initial layout for a trim photomask for the photoresist pattern depicted in FIG. 5A.

FIG. 5D is a diagram illustrating a final layout for a two-tone phase-shift photomask for the photoresist pattern depicted in FIG. 5A, after the inventive method has been applied.

FIG. 5E is a diagram illustrating a final layout for a trim photomask for the photoresist pattern depicted in FIG. 5A, after the inventive method has been applied.

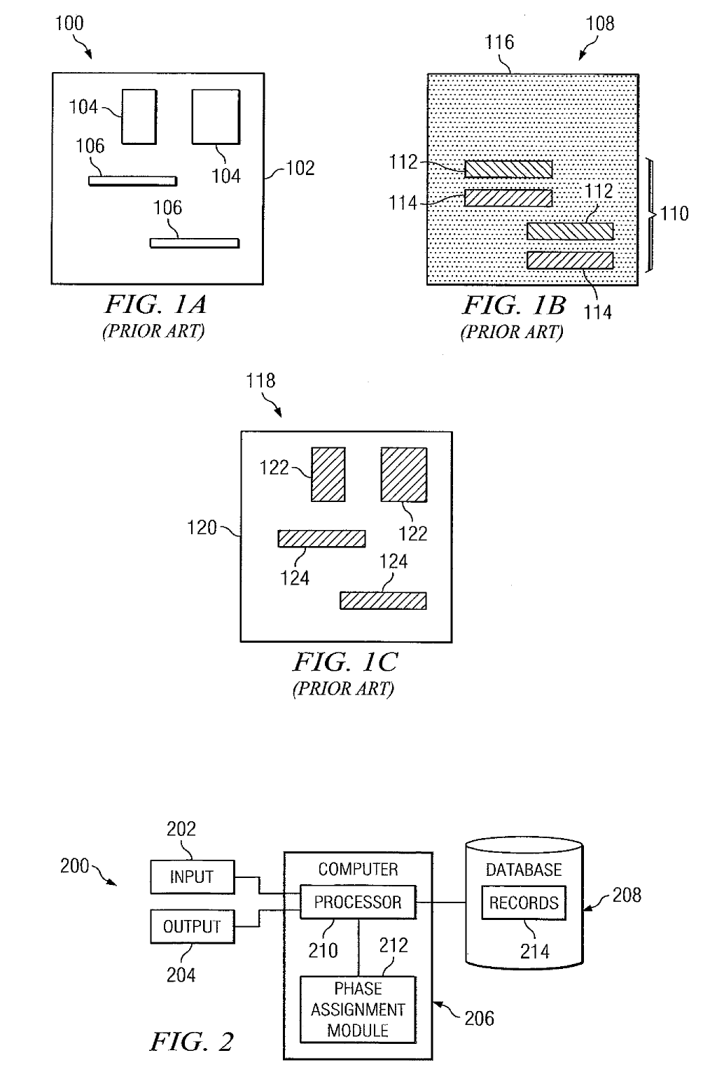

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

Lithography and photomask constraints may exist in two forms: “soft” constraints which can be relaxed to some degree, and “hard” constraints which cannot be relaxed. No exceptions to hard constraints are allowed. An example of a hard constraint is a requirement that adjacent polygons on a two-tone phase-shift photomask that define a minimum width line feature must have different phases. An example of a soft constraint is a guideline that adjacent polygons in a photomask are preferred to be separated by a prescribed minimum lateral distance; the prescribed lateral distance may be decreased by a relatively small amount, with some loss of photomask manufacturability and/or photolithographic process margin, as long as the final lateral distance is no smaller than a “hard constraint” minimum distance. Another example of a soft constraint is a guideline that polygons are preferred to have a prescribed minimum area; the prescribed minimum area may be decreased by a relatively small amount, with some loss of photomask manufacturability and/or photolithographic process margin, as long as the final polygon area is no smaller than a “hard constraint” minimum area. Thus, hard constraints are commonly accompanied by soft constraints; for example, the hard constraint that polygons must have a prescribed minimum area may be accompanied by a soft constraint that polygons having an area above, say, 200 percent of the prescribed minimum area, are preferred.

A “viable” phase assignment configuration is defined for the purposes of this disclosure as a set phase assignments to polygons in a photomask layout which meets all immediate photomask and lithography constraints, in which the term immediate refers to the hard and soft constraints in effect when a phase assignment is generated. For example, a viable phase assignment configuration would include polygons assigned phases using relaxed soft constraints, in which the amount of relaxation is determined by the inventive method.

Embodiments of the present invention and its advantages are best understood by referring to FIGS. 2, 3, 4A through 4C and 5A through 5E of the drawings, like numerals being used for like and corresponding parts of the various drawings.

FIG. 2 illustrates a system (200) for configuring polygons and phase assignments for the polygons on an alternating phase-shift photomask. System (200) includes an input device (202) and an output device (204) coupled to a computer (206), which is in turn coupled to a database (208). Input device (202) may comprise, for example, a keyboard, a mouse, or any other device suitable for transmitting data to computer (206). Output device (204) may comprise, for example, a display, a printer, or any other device suitable for outputting data received from computer (206).

Computer (206) may comprise a personal computer, workstation, network computer, wireless computer, or one or more microprocessors within these or other devices, or any other suitable processing device. Computer (206) may include a processor (210) and a phase assignment module (212) which may be embodied in software or hardware or both software and hardware. Processor (210) controls the flow of data between input device (202), output device (204), database (208), and phase assignment module (212).

Database (208) may store records (214) that include data associated with photomask layout polygons, lithography constraint violations, photomask constraint violations, and assignments of zero and π phase to photomask layout polygons.

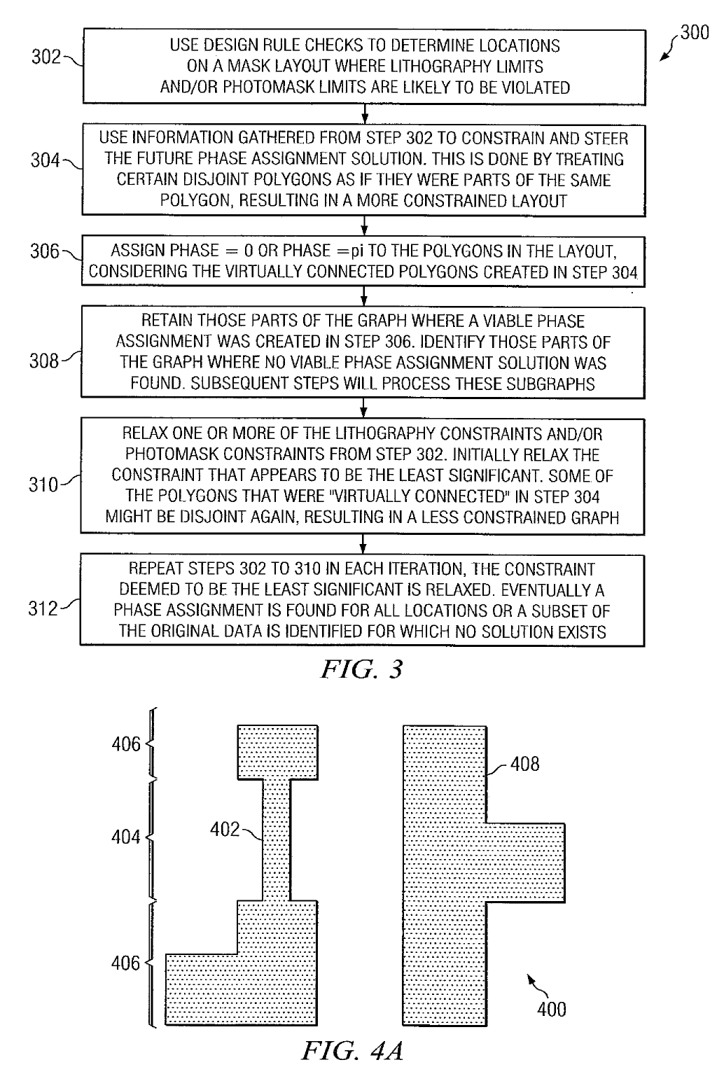

FIG. 3 is a flowchart 300 illustrating one embodiment of a method for configuring polygons and phase assignments for the polygons on an alternating phase-shift photomask. In step 302, the method uses design rule checks to determine locations on the photomask where lithography constraints and/or photomask constraints are violated.

The information gathered at step 302 about which locations on the photomask violate lithography constraints and/or photomask constraints is used to constrain and steer future phase assignment solutions. This is done, for example, by treating certain disjoint polygons as if they were part of the same polygon thereby creating a “virtually connected” polygon. This can result in a significantly more constrained phase assignment configuration. This step is shown at 304.

At step 306, the method attempts to assign a appropriate phases to the polygons in the phase-shift layout. For example, the method attempts to assign phase 0 or phase π to the polygons by considering the “virtually connected” polygons.

At step 308 the method then retains those parts of the layout where a viable phase assignment has been found. The method at this step also identifies those parts of the graph where no viable phase assignment solution has been found. Subsequent steps will process the parts of the graph where no viable phase assignment configuration has been found.

Next, the method relaxes one or more of the lithography constraints and/or photomask constraints so as to find additional phase assignment solutions for the parts of the graph where no phase assignment solution has been found previously. In a preferred embodiment, a constraint that appears to be the least significant can be relaxed first in order to possibly obtain a phase assignment solution. For example, the soft constraint specifying the preferred minimum lateral separation between adjacent polygons that do not define a feature in the layout may be reduced by a small relative amount to form a new soft constraint. In some cases, some of the polygons that were virtually connected may now be disjoint again, thereby resulting in a less constrained graph. This is shown at step 310.

At step 312, the method may iteratively proceed again through steps 302 to 310 to assign an appropriate phase to the polygons in the phase-shift layout. In each iteration, a constraint may be relaxed. For example, in each iteration, a constraint that is deemed to be the least significant is relaxed. Eventually, a phase assignment solution can be found for all locations, or a subset of polygons in the phase-shift layout can be identified for which no viable phase assignment configuration exists. In each iterative cycle only those polygons of the phase-shift layout for which no viable phase assignment configuration has been found may need to be analyzed. In this manner, each iteration treats less and less data. This can reduce the overall processing time.

Polygons where a viable phase assignment configuration cannot be generated may be considered “care-about” locations where further analysis or re-layout may be required.

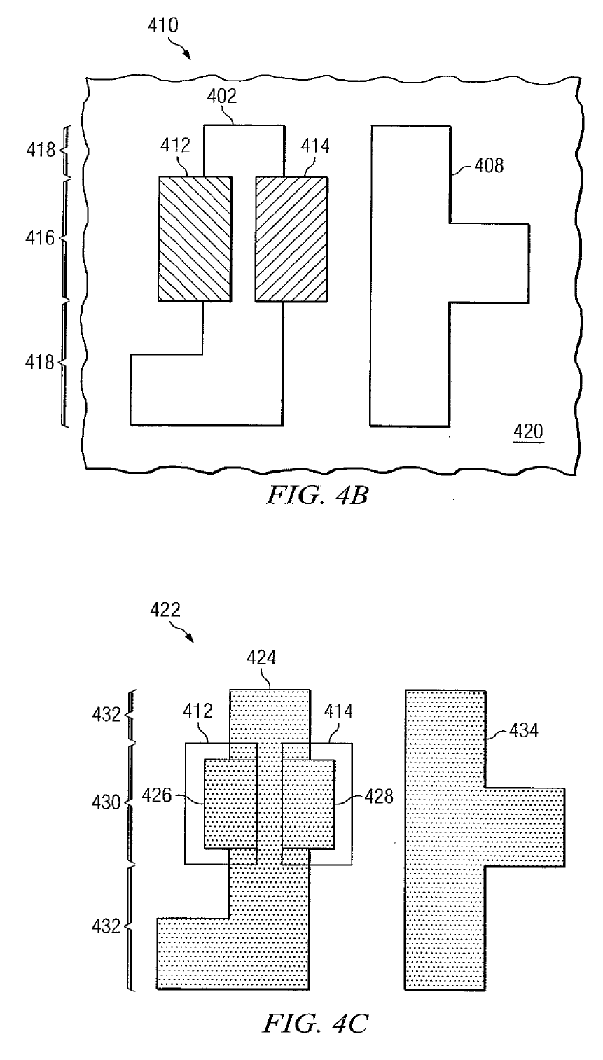

FIG. 4A through FIG. 4C illustrate assignment of phases to a photomask pattern that includes one or more polygons. Referring to FIG. 4A, a pattern (400) to be printed on a substrate includes a first pattern polygon (402) which contains a minimum width feature (404) and above minimum width features (406). Pattern (400) also contains a second pattern polygon (408) which has no minimum width features.

FIG. 4B depicts a phase shift photomask layout (410) for the pattern (400) in FIG. 4A. The first pattern polygon (402) and second pattern polygon (408) of the pattern to be formed on the substrate are shown in FIG. 4B for reference only; pattern polygons (402, 408) are not contained in the phase shift photomask layout (410). A first phase shift polygon (412) and a second phase shift polygon (414) are generated in the phase shift photomask layout (410) to define the minimum width feature, depicted in FIG. 4B as element (416). To define a minimum width feature, the phase shift polygons must have a different phase. In FIG. 4B, the first phase shift polygon (412) is assigned a phase of zero, while the second phase shift polygon (414) is assigned a phase of π. Widths of the phase shift polygons (412, 414) on the phase shift photomask are determined by photomask fabrication constraints and optical imaging considerations. Features (418) of the pattern significantly above the minimum width may require no phase shift polygons. Regions on the physical phase shift photomask corresponding to regions (420) in the phase shift photomask layout (410) outside the phase shift polygons (412, 414) are covered with chromium metal or other opaque material.

FIG. 4C depicts a trim photomask layout (422) for the pattern (400) in FIG. 4A. The phase shift polygons (412, 414) of the phase shift photomask layout (410) are shown in FIG. 4C for reference only; polygons (412, 414) are not contained in the trim photomask layout (422). Polygons in the trim photomask layout are generated by merging polygons of the pattern to be formed on the substrate with protection polygons to block light from minimum width features printed by the corresponding phase shift photomask, plus appropriate biases to account for photolithographic processing. Thus, in FIG. 4C, a first trim polygon (424) is formed by merging the first pattern polygon (402) in FIG. 4A with the protection polygons (426, 428) that block light from the minimum width feature (430) and applying a photolithographic process related bias. The first trim polygon (424) is wider in the region of the minimum width feature (430) and is substantially the size of the pattern features in above minimum width regions (432). A second trim polygon (434) is formed by applying photolithographic process biases to the second pattern polygon (408) in FIG. 4A; no phase shift polygons are used to form the second trim polygon (434) because the second pattern polygon (408) in FIG. 4A has no minimum width features. Regions on the physical trim photomask corresponding to trim polygons (424, 434) in the trim photomask layout (422) are covered with chromium metal or other opaque material.

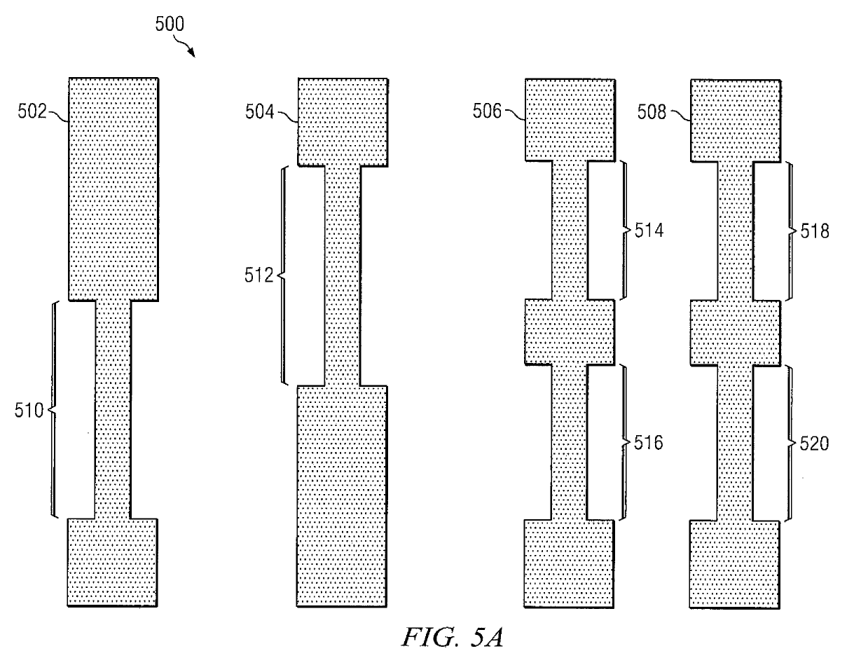

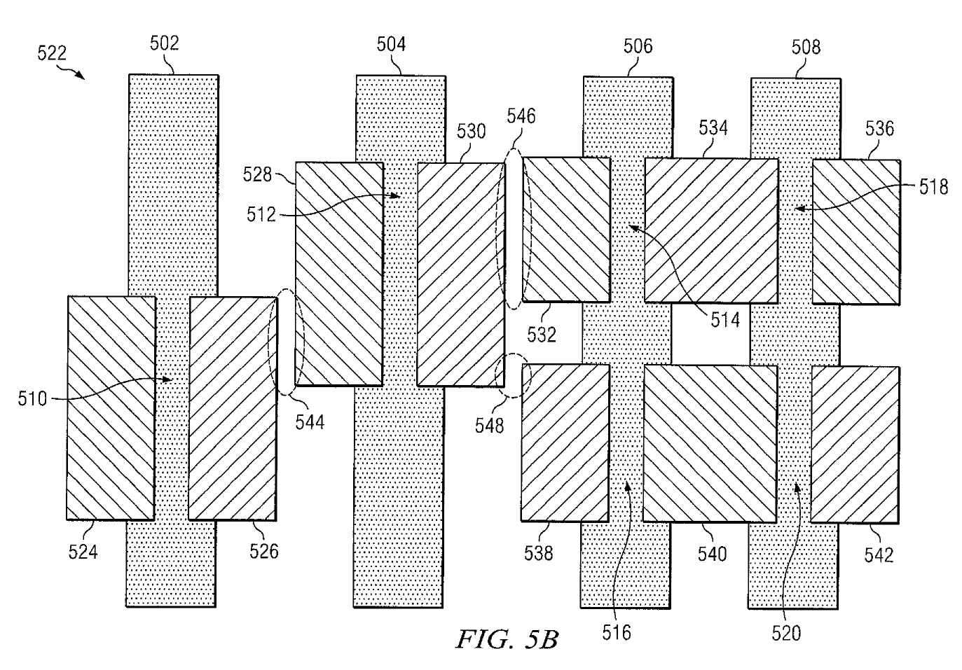

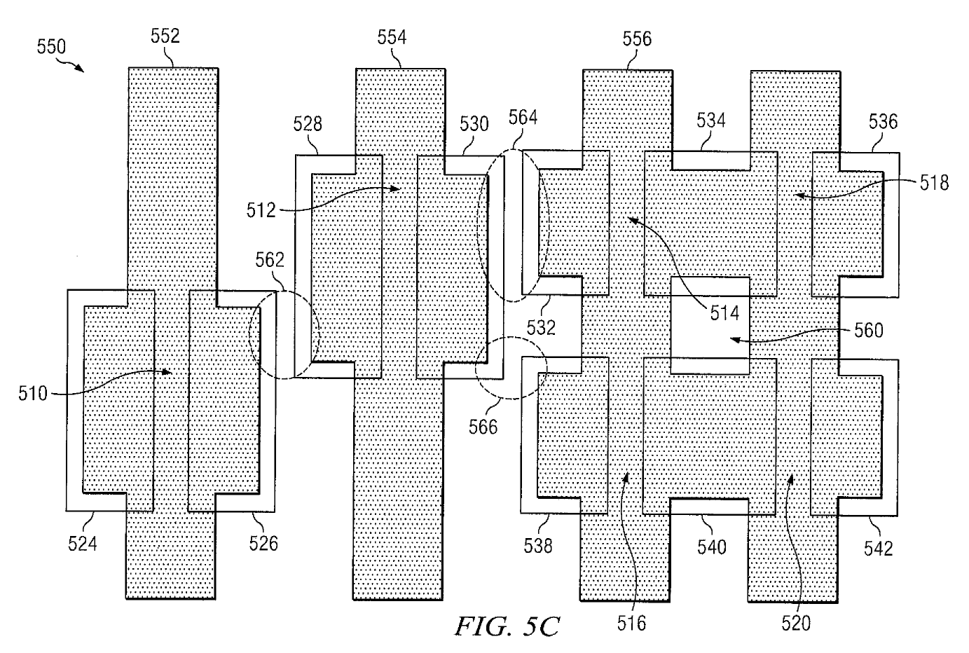

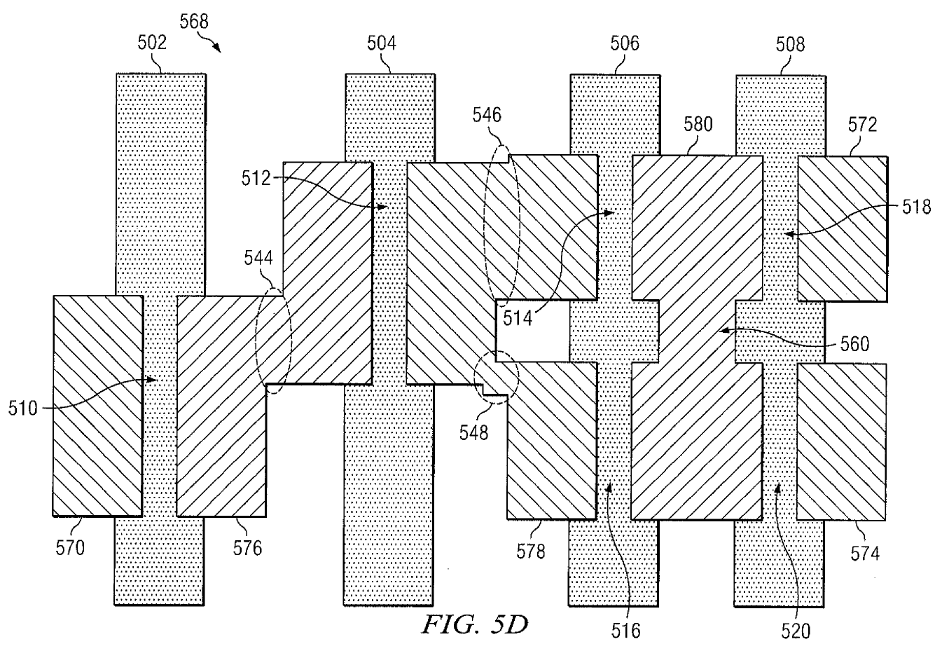

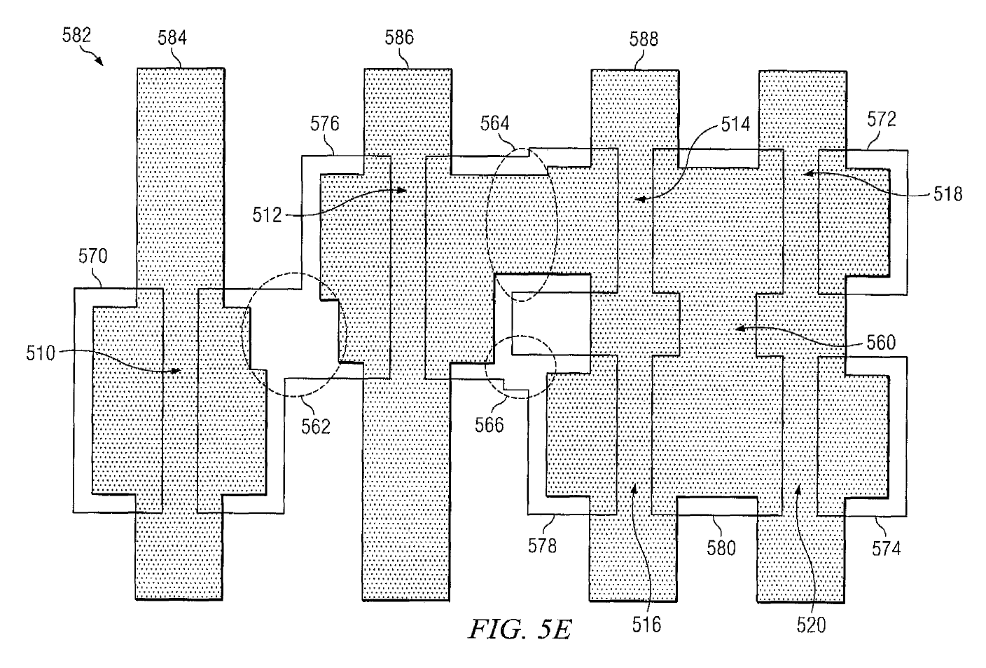

FIG. 5A through FIG. 5E depict an example of the inventive method generating an initial phase shift photomask layout and initial trim photomask layout, which have violations of lithography and photomask constraints, and a final phase shift photomask layout and final trim photomask layout which meet all lithography and photomask constraints. FIG. 5A depicts a pattern layout (500) to be formed in photoresist on a substrate, which includes a first pattern polygon (502), a second pattern polygon (504), a third pattern polygon (506) and a fourth pattern polygon (508). First pattern polygon (502) includes a first minimum width feature (510). Similarly, second pattern polygon (504) includes a second minimum width feature (512); third pattern polygon (506) includes a third minimum width feature (514) and a fourth minimum width feature (516); and fourth pattern polygon (508) includes a fifth minimum width feature (518) and a sixth minimum width feature (520).

FIG. 5B depicts a step in the generation of an initial phase shift photomask layout (522) in which initial phase shift polygons are positioned relative to the pattern polygons depicted in FIG. 5A. The pattern polygons (502, 504, 506, 508) are depicted in FIG. 5B for reference only; pattern polygons (502, 504, 506, 508) are not contained in the phase shift photomask layout (522). Minimum width features (510, 512, 514, 516, 518, 520) are also identified in FIG. 5B for reference purposes. At each minimum width feature in the pattern polygons (502, 504, 506, 508), initial phase shift polygons are generated on each side of the minimum width feature. Thus, first initial phase shift polygon (524) and second initial phase shift polygon (526) are generated adjacent to first minimum width feature (510). Similarly, third and fourth initial phase shift polygons (528, 530) are generated adjacent to second minimum width feature (512); additional initial phase shift polygons (532, 536, 538, 542) are generated adjacent to minimum width features (514, 516, 518, 520) as depicted in FIG. 5B. A minimum width of the initial phase shift polygons is determined by photomask fabrication constraints and optical imaging considerations. In some instances, initial phase shift polygons will overlap, in which cases the inventive method merges the overlapping initial phase shift polygons into a single polygon, as depicted in FIG. 5B by initial phase shift polygon (534), which resulted from a merger of an initial phase shift polygon adjacent to third minimum width feature (514) and an initial phase shift polygon adjacent to fifth minimum width feature (518). Similarly, initial phase shift polygon (540), is a result of a merger of an initial phase shift polygon adjacent to fourth minimum width feature (516) and an initial phase shift polygon adjacent to sixth minimum width feature (520). Violations of lithography and photomask constraints are depicted by elements (544, 546, 548), in which lateral distances between disjoint initial phase shift polygons are below a minimum value. An initial phase assignment for the phase shift polygons in FIG. 5B, in which polygons (524, 528, 532, 536, 540) are assigned a phase of zero, and polygons (526, 530, 534, 538, 542) are assigned a phase of π (3.14159 . . . ) radians, that is, 180 degrees, is depicted by the cross-hatching configuration. The inventive method alters initial phase shift polygons violating this constraint to produce a final phase shift photomask layout which does not violate this constraint, as will be seen in reference to FIG. 5D.

FIG. 5C depicts an initial trim photomask layout (550). FIG. 5C shows initial phase shift polygons (524, 526, 528, 530, 532, 534, 536, 538, 540, 542) from FIG. 5B for reference purposes; these initial phase shift polygons are not contained in the initial trim photomask layout (550). Similarly, FIG. 5C identifies minimum width features (510, 512, 514, 516, 518, 520) for reference purposes. Initial trim photomask layout (550) contains a first initial trim polygon (552) to form first pattern polygon (502 in FIG. 5A, not shown in FIG. 5C for clarity) and second initial trim polygon (554) to form second pattern polygon (504 in FIG. 5A, also not shown in FIG. 5C for clarity). Initial trim polygons are formed by merging pattern polygons with initial protection polygons and applying biases for photolithographic processes. In some instances, initial trim polygons will overlap, in which cases the inventive method merges the overlapping initial trim polygons into a single polygon, as depicted in FIG. 5C by third initial trim polygon (556) to form third and fourth pattern polygons (506, 508 in FIG. 5A, also not shown in FIG. 5C for clarity). A violation of lithography and photomask constraints is depicted in FIG. 5C by enclosed region (560), in which an area of the enclosed region is below a minimum value which cannot be relaxed. The inventive method alters initial phase shift and initial trim polygons violating this constraint to produce a final trim photomask layout which does not violate this constraint, as will be seen in reference to FIG. 5E. Another type of violation of lithography and photomask constraints is depicted by regions (562, 564, 566), in which lateral distances between adjacent initial trim polygons are below a preferred minimum value. The inventive method relaxes, that is reduces, the lateral distance minimum value during iterations of the algorithm, keeping the relaxed values above a “hard” minimum value which cannot be relaxed, to produce a final trim photomask layout which does not violate this constraint, as will be seen in reference to FIG. 5E.

FIG. 5D depicts a final phase shift photomask layout (568). The pattern polygons (502, 504, 506, 508) are depicted in FIG. 5D for reference only; pattern polygons (502, 504, 506, 508) are not contained in the final phase shift photomask layout (568). Minimum width features (510, 512, 514, 516, 518, 520) are also identified in FIG. 5D for reference purposes. Initial phase shift polygons in the initial phase shift photomask layout (522 in FIG. 5B, not shown in FIG. 5D for clarity) which are not associated with violations of lithography or photomask constraints may be copied into the final phase shift photomask layout (568) as shown in FIG. 5D by final phase shift polygons (570, 572, 574) which are copies of initial phase shift polygons (524, 536, 542) respectively. In the final phase shift photomask layout (568), violations of a constraint on lateral distances between initial phase shift polygons, denoted by (544, 546, 548) may be eliminated in iterations of the algorithm of the inventive method by joining the initial phase shift polygons by a bridging polygon and merging the initial phase shift polygons and bridging polygon to form a single final phase shift polygon. This is shown in FIG. 5D by final phase shift polygon (576) which is formed by joining initial phase shift polygons (526, 528 in FIG. 5B, not shown in FIG. 5D for clarity) to eliminate the violation denoted by region (544). Similarly, final phase shift polygon (578) is formed in iterations of the algorithm of the inventive method by joining initial phase shift polygons (530, 532, 538 in FIG. 5B, not shown in FIG. 5D for clarity) to eliminate the violations denoted by regions (546, 548). In addition, final phase shift polygon (578) has been adjusted at the location denoted by (548) to eliminate a violation of a minimum width constraint created by the bridging polygon. Violations of minimum area for enclosed regions in an initial trim photomask layout, as depicted by region (560) in FIG. 5C and FIG. 5D, may be eliminated in an iteration of the algorithm of the inventive method by adding a phase shift polygon and adding a trim polygon in the violation region (560), thus forming final phase shift polygon (580) as a result of a merger of initial phase shift polygons (534, 540 in FIG. 5B, not shown in FIG. 5D for clarity) and the added phase shift polygon in region (560).

FIG. 5E depicts a final trim photomask layout (582). The final phase shift polygons (570, 572, 574, 576, 578, 580) are depicted in FIG. 5E for reference only; final phase shift polygons (570, 572, 574, 576, 578, 580) are not contained in the final trim photomask layout (582). Minimum width features (510, 512, 514, 516, 518, 520) are also identified in FIG. 5E for reference purposes. Violations of a constraint on lateral distances between initial trim polygons, denoted by (562, 564, 566) may be eliminated by joining the violating polygons (586, 588) with a bridging polygon as depicted at location (564), by notching the violating polygons (584, 586) as depicted at location (562), or by relaxing the lateral distance minimum value as shown at location (566) during iterations of the algorithm of the inventive method, keeping the relaxed values above a “hard” minimum value which cannot be reduced, to produce final trim photomask polygons (584, 586, 588). Violations of minimum area for enclosed regions in an initial trim photomask layout, as depicted by region (560) in FIG. 5C, FIG. 5D and FIG. 5E, may be eliminated in an iteration of the algorithm of the inventive method by adding a phase shift polygon and adding a trim polygon in the violation region (560), as discussed above, thus forming a finalized version of final trim polygon (588).

Following the flow chart in FIG. 3, the starting point would be the initial phase shift photomask layout in FIG. 5B and the initial trim photomask layout in FIG. 5C. Note that FIG. 5B illustrates a naive assignment of phase zero and phase π to the phase shift photomask polygons. It will be shown that an a priori assignment of phase zero and phase π to polygons cannot be guaranteed to be viable.

In step (302) of FIG. 3, design rule checks are used to identify likely lithographic and/or photomask constraint violations on the initial phase shift photomask shown in regions (544,546,548) in FIG. 5B. Also in step (302) of FIG. 3, design rule checks are used to identify likely constraint violations on the initial trim photomask as shown in regions (562,564,566,560) in FIG. 5C.

In FIG. 5B, the lateral distance constraint violation at region (544) suggests that phase shift photomask polygons (526) and (528) may have to be bridged at some future step. Therefore disjoint polygons (526) and (528) will be treated as if they were parts of the same polygon (“virtually” connected). Similarly, phase polygons (530) and (532) will be virtually connected by the constraint violation at region (546), and the phase polygons (530) and (538) will be virtually connected by the violation at region (548).

In FIG. 5C, the lateral distance constraint violations at regions (562,564,566) in the trim photomask do not impact the assignment of phase zero and phase π to phase shift photomask polygons. However the minimum enclosed area violation at region (560) may require that the clear area be filled in on the trim photomask. The photoresist in this region will therefore have to be removed by the phase shift photomask, requiring that region (560) also be filled in (clear) on the phase shift photomask. This would result in phase polygons (534) and (540) in FIG. 5B being bridged. Therefore a trim photomask constraint violation at region (560) in FIG. 5C results in disjoint phase shift photomask polygons (534) and (540) in FIG. 5B being treated as parts of a single polygon (“virtually” connected).

In step (306) of FIG. 3, phase zero and phase π are assigned to the phase shift photomask polygons while being cognizant of the virtual connections created in step (304). Thus polygons (526) and (528) must be assigned to the same phase, polygons (530), (532) and (538) must be assigned to the same phase, and polygons (534) and (540) must be assigned to the same phase. A phase assignment solution that meets these requirements is shown in FIG. 5D.

In step (308) of FIG. 3, the assignment of phase zero and phase pi to the phase shift photomask polygons is validated. In locations where the phase assignment is determined to be valid, it is now possible to eliminate some constraint violations by modifying phase and/or trim polygons. Bridging polygons can be created to address lateral distance violations on the phase shift photomask at regions (544,546,548) as shown in FIG. 5D. Phase and trim can be filled in at region (560) as shown in FIG. 5D and FIG. 5E, respectively.

In step (310) of FIG. 3, we prepare for the second iteration. At this point, the assignment of phase zero and phase π is acceptable. Not having detected any insurmountable issues, it is not strictly necessary to relax any lithographic or photomask constraints at this time.

At the start of the second iteration, we again run design rule checks on the phase and trim polygons as shown in step (302) of FIG. 3. In the previous iteration, most of the phase constraint violations have been corrected, with the exception of a possible phase polygon width constraint at the bridging polygon at region (548) in FIG. 5B. The trim constraint violation at region (560) in FIG. 5C has been corrected, but the violations at (562,564,566) remain. Since no lateral distance constraints on the phase polygons are detected, it is not necessary to virtually connect any phase polygons or modify the assignment of phase zero and phase π to the phase polygons as shown in steps (304,306) of FIG. 3.

In step (308) of FIG. 3, we again modify the invalid subsets of the phase and trim photomask polygons to eliminate constraint violations. The phase polygon width violation at region (548) in FIG. 5B can be corrected by making it wider as shown in FIG. 5D. The trim polygon lateral distance violations at regions (562,564) in FIG. 5C are eliminated by notching the violating trim polygons and bridging the trim polygons, respectively.

In step (310) of FIG. 3, we prepare for the third iteration. At this point, the assignment configuration of phase zero and phase π is still acceptable. All lithographic and photomask constraints have been met, with the exception of a lateral distance constraint on the trim photomask at region (566) of FIG. 5E. The magnitude of this violation is not deemed to be significant, so the constraint is relaxed a small amount.

At the start of the third iteration, we again run design rule checks as shown in step (302) of FIG. 3. Use of virtual connecting of polygons and local repair strategies has eliminated most of the constraint violations. A small relaxation of a lateral spacing constraint has eliminated the sole remaining violation. At this point we have achieved a successful phase and trim photomask solution. The remaining steps in FIG. 3 are executed, resulting in no further modifications to the phase and trim polygons or the phase assignment. No further iterations are required.

The methods and systems described herein may be used to generate phase shift and trim patterns of various layers of integrated circuits. In one example, the methods and systems may be applied to generating patterns for a MOS transistor gate pattern. In another example, the interconnect parts of a metal pattern may be divided into base and relational segments for improved critical dimension correction, leaving the corners and contact/via pads to be corrected as traditional placement-correction segments.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”), or variants thereof are used in either the detailed description and the claims, such terms are intended to be inclusive in a manner similar to the term “comprising.”

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of designing a lithography photomask, the method comprising:
(a) identifying a first set of violating polygons from a plurality of polygons on a photomask layout of said lithography photomask that may violate a first set of design rules;
(b) generating a first set of phase assignments for said plurality of polygons so as to form a first set of conforming polygons that conform to said first set of design rules;
(c) relaxing one or more design rules in said first set of design rules to form a second set of design rules;
(d) adjusting geometries of polygons in said first set of violating polygons to eliminate violations in said second set of design rules; and
(e) generating a second set of phase assignments for said plurality of polygons, whereby a number of polygons violating said second set of design rules is a minimum number compared to any other set of phase assignments.

2. The method of designing a lithography photomask according to claim 1, wherein said step of adjusting geometries of polygons further comprises joining adjacent polygons with new polygons.

3. The method of designing a lithography photomask according to claim 2, wherein said first set of phase assignments and said second set of phase assignments consist of assignments of either zero phase or π (3.14159 . . . ) radians, that is, 180 degrees, phase.

4. The method of designing a lithography photomask according to claim 3 further comprising:
(f) identifying a second set of violating polygons from said plurality of polygons that may violate said second set of design rules;
(g) relaxing one or more design rules in said second set of design rules to form a third set of design rules;
(h) adjusting geometries of polygons in said second set of violating polygons to eliminate violations in said third set of design rules; and
(i) generating a third set of phase assignments for said plurality of polygons, whereby a number of polygons violating said third set of design rules is a minimum number compared to any other set of phase assignments.

5. The method of designing a lithography photomask according to claim 4, further comprising:
(j) repeating steps (f) through (i) until a set of phase assignments is found which reduces said number of polygons violating said third set of design rules.

6. The method of designing a lithography photomask according to claim 5, wherein said first set of design rules comprises lithography limits and photomask limits.

7. A computer readable medium containing program code that configures a processor to perform a method of designing a lithography photomask, the computer readable medium comprising:
program code for identifying a first set of violating polygons from a plurality of polygons on a photomask layout of said lithography photomask that may violate a first set of design rules;
program code for generating a first set of phase assignments for said plurality of polygons so as to form a first set of conforming polygons that conform to said first set of design rules;
program code for relaxing one or more design rules in said first set of design rules to form a second set of design rules;
program code for adjusting geometries of polygons in said first set of violating polygons to eliminate violations in said second set of design rules; and
program code for generating a second set of phase assignments for said plurality of polygons, whereby a number of polygons violating said second set of design rules is a minimum number compared to any other set of phase assignments.

8. The computer readable medium containing program code that configures a processor to perform a method designing a lithography photomask according to claim 7, wherein said program code for adjusting geometries of polygons further comprises program code for joining adjacent polygons with new polygons.

9. The computer readable medium containing program code that configures a processor to perform a method designing a lithography photomask according to claim 8, wherein said program code for generating said first set of phase assignments and said second set of phase assignments consists of assignments of either zero phase or π (3.14159 . . . ) radians, that is, 180 degrees, phase.

10. The computer readable medium containing program code that configures a processor to perform a method designing a lithography photomask according to claim 9 further comprising:
program code for identifying a second set of violating polygons from said plurality of polygons that may violate said second set of design rules;
program code for relaxing one or more design rules in said second set of design rules to form a third set of design rules;
program code for adjusting geometries of polygons in said second set of violating polygons to eliminate violations in said third set of design rules; and
program code for generating a third set of phase assignments for said plurality of polygons, whereby a number of polygons violating said third set of design rules is a minimum number compared to any other set of phase assignments.

11. The computer readable medium containing program code that configures a processor to perform a method designing a lithography photomask according to claim 10 further comprising:
program code for repeating steps described in claim 10 until a set of phase assignments is found which reduces said number of polygons violating said third set of design rules.

12. The computer readable medium containing program code that configures a processor to perform a method designing a lithography photomask according to claim 11, wherein said first set of design rules comprises lithography limits and photomask limits.
